(19) United States
(12) Patent Application Publication
(10) Pub. No.: US 2015/0138317 A1
(43) Pub. Date: May 21, 2015

(54) SYSTEM AND METHOD FOR PROVIDING THREE-DIMENSIONAL (3D) BROADCAST SERVICE BASED ON RETRANSMISSION NETWORKS

(71) Applicants: Electronics and Telecommunications Research Institute, Daejeon (KR); Hidea Solutions Co., Ltd, Seoul (KR); Kookmin University Industry Academy Cooperation Foundation, Seoul (KR)

(72) Inventors: Joo Young LEE, Daejeon (KR); Sung Hoon KIM, Daejeon (KR); Hyon Gon CHOO, Daejeon (KR); Jin Soo CHOI, Daejeon (KR); Jin Woong KIM, Daejeon (KR); Suk Jin HONG, Seoul (KR); Jin Suk KWAK, Daejeon (KR); Dong Wook KANG, Seoul (KR); Kyeong Hoon JUNG, Seoul (KR)

(21) Appl. No.: 14/531,713

(22) Filed: Nov. 3, 2014

(30) Foreign Application Priority Data
Nov. 18, 2013 (KR) 10-2013-0140119

(51) Int. Cl. H04N 13/00; H04N 21/2343; H04N 21/2362; H04N 21/6375; H04N 21/235; H04N 21/236; H04N 21/81; H04N 21/242

(52) U.S. Cl. CPC H04N 13/0059; H04N 13/0048; H04N 13/0066; H04N 13/0051; H04N 21/816; H04N 21/234309; H04N 21/242; H04N 21/6375; H04N 21/2355; H04N 21/23608; H04N 21/2362
USPC 348/43

(57) ABSTRACT

A system and method for providing a three-dimensional (3D) broadcast service based on a retransmission network are provided. A 3D broadcast retransmission apparatus in a 3D broadcast service providing system may include a remultiplexer to remultiplex 3D TV service information in a received stream of a first broadcast network, based on a retransmission scenario, and to generate a stream of a retransmission network, and a retransmission network transmitter to transmit the stream of the retransmission network through the retransmission network.

### CROSS-REFERENCE TO RELATED APPLICATION

This application claims the benefit of Korean Patent Application No. 10-2013-0140119, filed on Nov. 18, 2013, in the Korean Intellectual Property Office, the disclosure of which is incorporated herein by reference.

### BACKGROUND

1. Field of the Invention

Embodiments of the present invention relate to a three-dimensional (3D) broadcast service providing system and method based on a retransmission network, and more particularly, to a system and method for providing a 3D broadcast service using an apparatus for retransmitting a terrestrial two-dimensional (2D) broadcast.

2. Description of the Related Art

Binocular three-dimensional (3D) content may include a left eye image and a right eye image. Accordingly, a broadcast system may need to transmit two images to provide a binocular 3D TV broadcast service.

The 3D image may occupy a large number of broadcast bandwidths, compared to a two-dimensional (2D) image, because the two images need to be transmitted.

Accordingly, a convergence 3D TV technology has been developed. In the convergence 3D TV technology, one of two images of a 3D image may be transmitted through a terrestrial 2D broadcast network and the other image may be transmitted through a heterogeneous broadcast network, for example, a mobile broadcast network, a cable broadcast network, a satellite broadcast network, and an Internet protocol television (IPTV) broadcast network.

However, since one of the two images is transmitted through the terrestrial 2D broadcast network in the convergence 3D TV technology, a coverage may be extremely lower than that of a broadcast system for transmitting both the two images through a heterogeneous broadcast network, due to a characteristic of a terrestrial broadcast environment.

Accordingly, there is a desire for a method for maximizing a coverage while transmitting one of two images of a 3D image through a terrestrial 2D broadcast network.

### SUMMARY

An aspect of the present invention provides a system and method for maximizing a coverage by retransmitting one of two images of a three-dimensional (3D) image that is transmitted through a terrestrial broadcast network, using a heterogeneous broadcast network, for example, a cable broadcast network, a satellite broadcast network, and an Internet protocol television (IPTV) broadcast network, in a convergence 3D TV in which the terrestrial broadcast network and the heterogeneous broadcast network are simultaneously used.

Another aspect of the present invention provides an apparatus and method for enabling synchronization between one of two images of a 3D image retransmitted in a reception apparatus and the other image received through a heterogeneous broadcast network, by providing additional service information when image-related information is changed during retransmitting of one of the two images transmitted through a terrestrial broadcast network, using the heterogeneous broadcast network in a convergence 3D TV.

According to an aspect of the present invention, there is provided a 3D broadcast service providing system including: a broadcast server to transmit a stream of a first broadcast network through the first broadcast network, and to transmit a stream of a second broadcast network corresponding to the stream of the first broadcast network through the second broadcast network, the stream of the first broadcast network being a terrestrial stream, the first broadcast network being different from the second broadcast network; a 3D broadcast retransmission apparatus to generate a stream of a retransmission network by remultiplexing the stream of the first broadcast network received through the first broadcast network, and to transmit the stream of the retransmission network through the retransmission network; and a 3D broadcast reception apparatus to receive the stream of the retransmission network and the stream of the second broadcast network, to generate a 3D image by synchronizing a retransmission network image included in the stream of the retransmission network with a second broadcast network image included in the stream of the second broadcast network.

The 3D broadcast retransmission apparatus may include a remultiplexer to remultiplex 3D TV service information included in the received stream of the first broadcast network based on a retransmission scenario, and to generate the stream of the retransmission network, and a retransmission network transmitter to transmit the stream of the retransmission network through the retransmission network.

The retransmission scenario used by the 3D broadcast retransmission apparatus may include at least one of a scenario for bypassing the stream of the first broadcast network, a scenario for remodulating or transmodulating the stream of the first broadcast network, a scenario for remodulating and remultiplexing the stream of the first broadcast network, and a scenario for remodulating, remultiplexing, and transcoding the stream of the first broadcast network.

When either the scenario for bypassing the stream of the first broadcast network, or the scenario for remodulating or transmodulating the stream of the first broadcast network is used as the retransmission scenario, the remultiplexer may generate a stream of the retransmission network that includes the same type of 3D TV service information as the 3D TV service information in the stream of the first broadcast network.

When either the scenario for remodulating and remultiplexing the stream of the first broadcast network, or the scenario for remodulating, remultiplexing, and transcoding the stream of the first broadcast network is used as the retransmission scenario, the remultiplexer may extract the 3D TV service information from the stream of the first broadcast network, and may reinsert the extracted 3D TV service information.

The 3D TV service information extracted by the 3D broadcast retransmission apparatus may include at least one of 3D TV service type information, identification information of the stream of the first broadcast network, identification information of the stream of the second broadcast network, location information of a left image included in the stream of the first broadcast network or the stream of the second broadcast network, location information of a right image included in the stream of the first broadcast network or the stream of the second broadcast network, video format information used to generate a 3D image by synthesizing an image in the stream of the first broadcast network and an image in the stream of the second broadcast network, and synchronization information of an image in each of the stream of the first broadcast network and the stream of the second broadcast network.

When a broadcast channel number, a program identifier (ID), or a packet ID is changed, the remultiplexer may change the identification information of the stream of the first broadcast network, and the identification information of the stream of the second broadcast network, based on the changed broadcast channel number, the changed program ID, or the changed packet ID.

When at least one of transcoding, up-sampling, down-sampling, and changing of a frame rate is performed on the image in the stream of the first broadcast network, the remultiplexer may correct the video format information based on information changed during remultiplexing of the stream of the first broadcast network.

When at least one of transcoding, up-sampling, down-sampling, and changing of a frame rate is performed on the image in the stream of the first broadcast network, the remultiplexer may transmit the video format information changed during remultiplexing of the stream of the first broadcast network, using a separate signaling scheme.

When at least one of remultiplexing and transcoding is performed on the image in the stream of the first broadcast network, the remultiplexer may correct the synchronization information.

The 3D broadcast reception apparatus may include a service information extractor to extract 3D TV service information from the stream of the retransmission network received from the 3D broadcast retransmission apparatus, a synchronization unit to synchronize the retransmission network image with the second broadcast network image, based on the 3D TV service information, and a 3D image synthesizing unit to synthesize the retransmission network image and the second broadcast network image to a 3D image, and to output the 3D image.

The service information extractor may extract 3D TV service information from a signaling channel of the retransmission network.

The 3D broadcast receiving apparatus may further include a service information interpreting unit to interpret the 3D TV service information extracted by the service information extractor, and to acquire information required for 3D image synthesis based on the interpreted 3D TV service information.

When the extracted 3D TV service information includes additional service information in addition to 3D TV service information included in the stream of the first broadcast network, the service information interpreting unit may interpret the additional service information based on a type of information used as left and right image synchronization information.

According to another aspect of the present invention, there is provided a 3D broadcast retransmission method, including: remultiplexing 3D TV service information included in a received stream of a first broadcast network based on a retransmission scenario, and generating a stream of a retransmission network; and transmitting the stream of the retransmission network through the retransmission network.

According to another aspect of the present invention, there is provided a 3D broadcast reception method, including: extracting 3D TV service information from a stream of a retransmission network received from a 3D broadcast retransmission apparatus; synchronizing a retransmission network image included in the stream of the retransmission network with a second broadcast network image included in a stream of a second broadcast network received from a broadcast server, based on the 3D TV service information; and synthesizing the retransmission network image and the second broadcast network image to a 3D image, and outputting the 3D image.

### Effect

According to embodiments of the present invention, it is possible to maximize a coverage by retransmitting one of two images of a three-dimensional (3D) image that is transmitted through a terrestrial broadcast network, using a heterogeneous broadcast network, for example, a cable broadcast network, a satellite broadcast network, and an Internet protocol television (IPTV) broadcast network, in a convergence 3D TV in which the terrestrial broadcast network and the heterogeneous broadcast network are simultaneously used.

Additionally, according to embodiments of the present invention, it is possible to synthesize, to a 3D image, one of two images of the 3D image retransmitted in a reception apparatus and the other image received from a broadcast server, by changing or adding left and right broadcast service identification information, image information, and synchronization information based on a retransmission environment during retransmitting of one of the two images transmitted through a terrestrial broadcast network, using a heterogeneous broadcast network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a three-dimensional (3D) broadcast service providing system according to an embodiment of the present invention;

FIG. 2 is a block diagram illustrating a 3D broadcast retransmission apparatus of FIG. 1;

FIG. 3 is a diagram illustrating an example of 3D TV service information according to an embodiment of the present invention;

FIG. 4 illustrates 3D broadcast retransmission scenarios according to an embodiment of the present invention;

FIG. 5 is a block diagram illustrating a 3D broadcast reception apparatus of FIG. 1;

FIG. 6 is a flowchart illustrating a 3D broadcast retransmission method according to an embodiment of the present invention; and

FIG. 7 is a flowchart illustrating a 3D broadcast reception method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A three-dimensional (3D) broadcast retransmission method according to an embodiment of the present invention may be performed by a 3D broadcast retransmission apparatus in a 3D broadcast service providing system. Additionally, a 3D broadcast reception method according to an embodiment of the present invention may be performed by a 3D broadcast reception apparatus in the 3D broadcast service providing system.

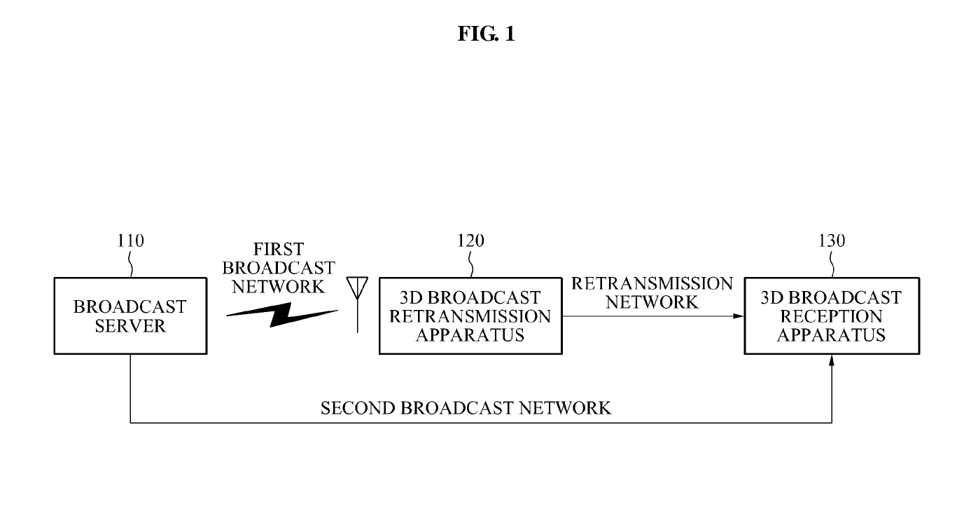

FIG. 1 is a diagram illustrating a 3D broadcast service providing system according to an embodiment of the present invention.

Referring to FIG. 1, the 3D broadcast service providing system may include a broadcast server 110, a 3D broadcast retransmission apparatus 120, and a 3D broadcast reception apparatus 130.

The broadcast server 110 may form a 3D broadcast network based on a first broadcast network and a second broadcast network, as shown in FIG. 1. The first broadcast network may be a terrestrial broadcast network for two-dimensional (2D) TV services. For example, the first broadcast network may be a broadcast network based on a broadcast standard, for example, Advanced Television System Committee (ATSC), Digital Video Broadcasting-Terrestrial (DVB-T), Digital Video Broadcasting-Second Generation Terrestrial (DVB-T2), Integrated Services Digital Broadcasting-Terrestrial (ISDB-T), and Integrated Services Digital Broadcasting, Terrestrial, Brazilian version (ISDB-Tb).

Additionally, the broadcast server 110 may transmit a stream of the first broadcast network through the first broadcast network. The stream of the first broadcast network may refer to a stream for 2D TV services. Additionally, the stream of the first broadcast network may be used as one of two images for a 3D TV service.

The second broadcast network may be identical to a retransmission network used by the 3D broadcast retransmission apparatus 120 to retransmit the stream of the first broadcast network to the 3D broadcast reception apparatus 130. The second broadcast network may include, for example, one of a terrestrial digital television (DTV) broadcast network, a mobile broadcast network, an Internet protocol television (IPTV) broadcast network, a satellite broadcast network, an exclusive broadband network, and a network used to transmit a non-real time (NRT) broadcast stream.

The second broadcast network may be different from the retransmission network. For example, the retransmission network may be a cable broadcast network or a satellite broadcast network, and the second broadcast network may be a mobile network. The 3D broadcast reception apparatus 130 may extract 3D TV service information from a stream of the retransmission network received from the 3D broadcast retransmission apparatus 120, and may receive a stream of the second broadcast network based on the 3D TV service information.

The broadcast server 110 may transmit the stream of the second broadcast network corresponding to the stream of the first broadcast network, through the second broadcast network. For example, when the 3D broadcast reception apparatus 130 uses an image included in the stream of the first broadcast network, that is, the retransmission network as a right image of a 3D image, the stream of the second broadcast network may include an image that is to be used as a left image of the 3D image.

Additionally, the stream of the second broadcast network may be used to independently provide a 2D service.

The 3D broadcast retransmission apparatus 120 may transmit, through the retransmission network, the stream of the first broadcast network received through the first broadcast network. The retransmission network may include, for example, one of a terrestrial DTV broadcast network, a mobile broadcast network, an IPTV broadcast network, a satellite broadcast network, and an exclusive broadband network.

The 3D broadcast retransmission apparatus 120 may receive the stream of the first broadcast network over a terrestrial broadcast network for 2D TV services, may remultiplex the stream of the first broadcast network based on the stream of the second broadcast network, and may transmit the stream of the retransmission network.

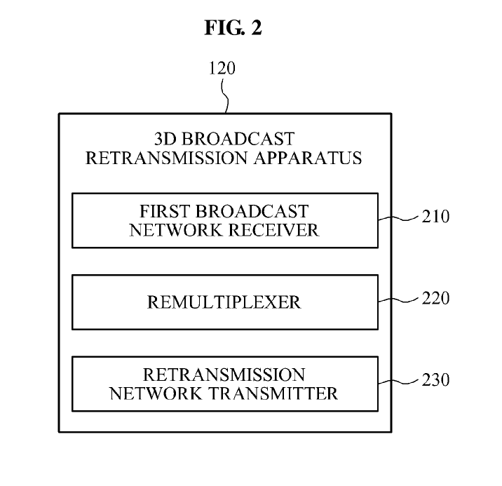

A configuration and an operation of the 3D broadcast retransmission apparatus 120 will be further described with reference to FIG. 2.

The 3D broadcast reception apparatus 130 may simultaneously receive the stream of the retransmission network and the stream of the second broadcast network from the 3D broadcast retransmission apparatus 120 and the broadcast server 110, respectively.

The 3D broadcast reception apparatus 130 may extract 3D TV service information from the received stream of the retransmission network.

The 3D broadcast reception apparatus 130 may synchronize a retransmission network image included in the stream of the retransmission network with a second broadcast network image included in the stream of the second broadcast network, based on the extracted 3D TV service information.

The 3D broadcast reception apparatus 130 may synthesize the retransmission network image and the second broadcast network image to a 3D image, and may output the 3D image. Accordingly, the 3D image may be reproduced.

Additionally, the 3D broadcast reception apparatus 130 may be configured by adding a function of receiving the stream of the second broadcast network to a broadcast reception apparatus of a conventional retransmission system.

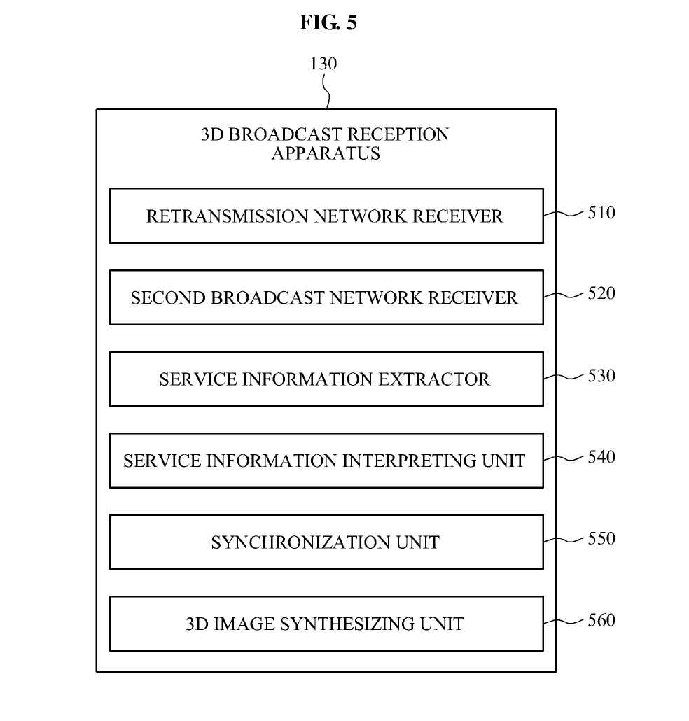

A configuration and an operation of the 3D broadcast reception apparatus 130 will be further described with reference to FIG. 5.

FIG. 2 is a block diagram illustrating the 3D broadcast retransmission apparatus 120 of FIG. 1.

Referring to FIG. 2, the 3D broadcast retransmission apparatus 120 may include a first broadcast network receiver 210, a remultiplexer 220, and a retransmission network transmitter 230.

The first broadcast network receiver 210 may receive the stream of the first broadcast network from the broadcast server 110 through the first broadcast network. Since the first broadcast network is a terrestrial 2D TV broadcast network, the stream of the first broadcast network may be a stream of a terrestrial broadcast network.

The remultiplexer 220 may extract 3D TV service information from the stream of the first broadcast network received by the first broadcast network receiver 210, may remultiplex the extracted 3D TV service information based on a retransmission scenario, and may generate a stream of the retransmission network.

The 3D TV service information extracted by the remultiplexer 220 may include at least one of 3D TV service type information, identification information of each of the stream of the first broadcast network and the stream of the second broadcast network, location information of a left image included in the stream of the first broadcast network or the stream of the second broadcast network, location information of a right image included in the stream of the first broadcast network or the stream of the second broadcast network, video format information used to generate a 3D image by synthesizing an image included in the stream of the first broadcast network and an image included in the stream of the second broadcast network, and synchronization information of an image included in each of the stream of the first broadcast network and the stream of the second broadcast network.

Additionally, the retransmission scenario used by the remultiplexer 220 may include at least one of a scenario for bypassing the stream of the first broadcast network, a scenario for remodulating or transmodulating the stream of the first broadcast network, a scenario for remodulating and remultiplexing the stream of the first broadcast network, and a scenario for remodulating, remultiplexing, and transcoding the stream of the first broadcast network.

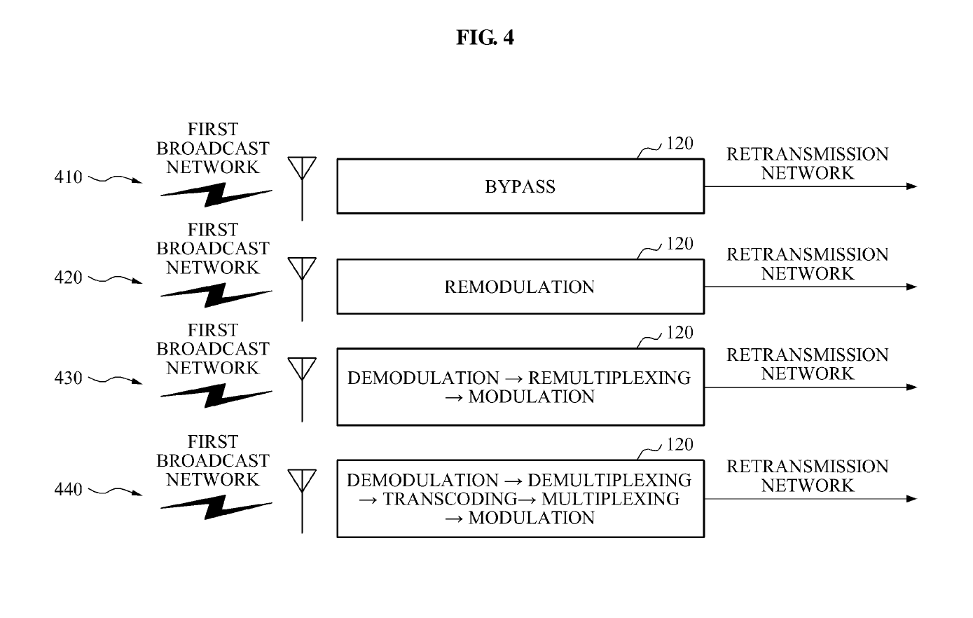

Operations of retransmission scenarios used by the remultiplexer 220 will be further described with reference to FIG. 4.

In an example, when either the scenario for bypassing the stream of the first broadcast network, or the scenario for remodulating or transmodulating the stream of the first broadcast network is used as the retransmission scenario, the remultiplexer 220 may perform the retransmission scenario, and may not remultiplex the 3D TV service information. In this example, the remultiplexer 220 may not change the 3D TV service information, and accordingly a stream of the retransmission network generated by the remultiplexer 220 may include the same type of 3D TV service information as the 3D TV service information included in the stream of the first broadcast network.

In another example, when either the scenario for remodulating and remultiplexing the stream of the first broadcast network, or the scenario for remodulating, remultiplexing, and transcoding the stream of the first broadcast network is used as the retransmission scenario, the remultiplexer 220 may extract the 3D TV service information from the stream of the first broadcast network. In this example, the remultiplexer 220 may change the 3D TV service information, and may reinsert the changed 3D TV service information, if necessary.

When a portion of the 3D TV service information is changed, the remultiplexer 220 may update the extracted 3D TV service information based on a change in the 3D TV service information, and may transmit the updated 3D TV service information. Additionally, the remultiplexer 220 may transmit the updated 3D TV service information, separately from the extracted 3D TV service information. A format of the updated 3D TV service information may be identical to, or different from a format of the extracted 3D TV service information.

For example, the identification information, the video format information, and the synchronization information in the 3D TV service information may be changed. In this example, the remultiplexer 220 may update the extracted 3D TV service information, based on the changed identification information, the changed video format information, and the changed synchronization information.

For example, during remultiplexing based on the retransmission scenario, identification information of the stream of the first broadcast network may be changed. The identification information of the stream of the first broadcast network may include, for example, a broadcast channel number of a virtual channel table (VCT) in a program and system information protocol (PSIP), a program identifier (ID) of a virtual channel table, or a packet ID of a moving picture experts group-2 transport stream (MPEG-2 TS) included in an image stream of a broadcast program. The remultiplexer 220 may change the identification information of the stream of the first broadcast network and the identification information of the stream of the second broadcast network, based on the broadcast channel number, the program ID, or the packet ID that is changed during the remultiplexing.

Additionally, during remultiplexing based on the retransmission scenario, transcoding, up-sampling, down-sampling, and changing of a frame rate may be performed on an image included in the stream of the first broadcast network. For example, the remultiplexer 220 may correct the video format information in the 3D TV service information extracted from the stream of the first broadcast network, based on video format information changed by the transcoding, the up-sampling, the down-sampling, and the changing of the frame rate during remultiplexing of the stream of the first broadcast network.

The remultiplexer 220 may also transmit the changed video format information using a separate signaling scheme. For example, a separate descriptor may be used the remultiplexer 220 to transmit the changed video format information.

When the image in the stream of the first broadcast network is remultiplexed or transcoded, the remultiplexer 220 may correct the synchronization information included in the 3D TV service information, or may transmit additional synchronization information.

In an example, when an existing timestamp is incremented by N in response to an input of a new timestamp for each access unit (AU) delimiter of the first broadcast network, and when the broadcast server 110 uses a timestamp pair as left and right image synchronization information, the remultiplexer 220 may increment, by N, a timestamp value corresponding to the first broadcast network in the timestamp pair.

In another example, when an existing timestamp is incremented by N in response to an input of a new timestamp for each AU of the first broadcast network, and when the broadcast server 110 uses a timestamp offset value of the stream of the first broadcast network and the stream of the second broadcast network as left and right image synchronization information, the remultiplexer 220 may increment or decrement the timestamp offset value by N.

In this example, the remultiplexer 220 may determine whether to increment or decrement the timestamp offset value, based on an initial offset calculation scheme. Additionally, the remultiplexer 220 may perform a modular arithmetic based on a bit length of an offset field during incrementing or decrementing of the timestamp offset value by N, to prevent the timestamp offset value from exceeding a range in which an offset value may be expressed by a predetermined bit string.

In still another example, when an existing timestamp is incremented by N in response to an input of a new timestamp for each AU of the first broadcast network, and when the broadcast server 110 uses a timestamp pair or a timestamp offset as left and right image synchronization information, the remultiplexer 220 may perform separate signaling of a timestamp change value N, instead of changing the synchronization information in the 3D TV service information extracted from the stream of the first broadcast network.

Additionally, the remultiplexer 220 may separately designate and use, as left and right image synchronization information, a frame number or a time code of the Society of Motion Picture and Television Engineers (SMPTE) standard assigned to each image. The remultiplexer 220 may not update the left and right image synchronization information, despite a change in a timestamp assigned to each AU within the stream of the first broadcast network.

The retransmission network transmitter 230 may transmit the stream of the retransmission network generated by the remultiplexer 220 through the retransmission network.

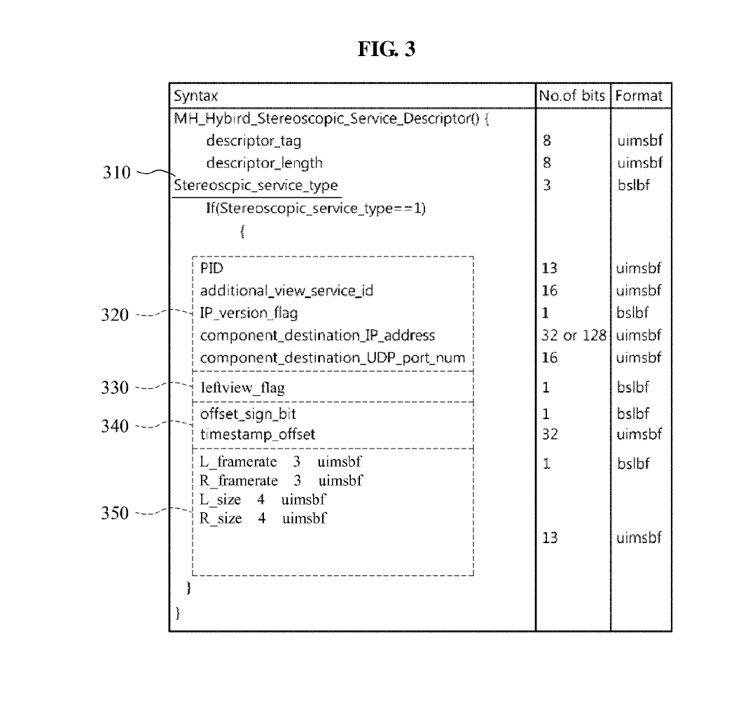

FIG. 3 is a diagram illustrating an example of 3D TV service information according to an embodiment of the present invention.

Referring to FIG. 3, the 3D TV service information extracted by the remultiplexer 220 of FIG. 2 may include 3D TV service type information 310, identification information 320 of each of the stream of the first broadcast network and the stream of the second broadcast network, information 330 including location information of a left image included in the stream of the first broadcast network or the stream of the second broadcast network, or location information of a right image included in the stream of the first broadcast network or the stream of the second broadcast network, synchronization information 340 between left and right images included in the stream of the first broadcast network and the stream of the second broadcast network, respectively, and video format information 350 used to generate a 3D image by synthesizing an image included in the stream of the first broadcast network and an image included in the stream of the second broadcast network.

FIG. 4 illustrates 3D broadcast retransmission scenarios according to an embodiment of the present invention.

Referring to FIG. 4, in a first scenario 410 among retransmission scenarios of a first broadcast network, the 3D broadcast retransmission apparatus 120 may bypass a stream of the first broadcast network received through the first broadcast network, and may transmit the stream of the first broadcast network through the retransmission network. For example, in the first scenario 410, the 3D broadcast retransmission apparatus 120 may transmit the stream of the first broadcast network over the retransmission network, instead of correcting a bit string of the stream of the first broadcast network.

In a second scenario 420 among the retransmission scenarios, the 3D broadcast retransmission apparatus 120 may remodulate or transmodulate the stream of the first broadcast network by changing a modulation scheme and a channel between the first broadcast network and the retransmission network, and may generate a stream of the retransmission network, as shown in FIG. 4. Additionally, the 3D broadcast retransmission apparatus 120 may transmit the stream of the retransmission network using the retransmission network.

A third scenario 430 among the retransmission scenarios may be generated by adding a remultiplexing operation to the second scenario 420. The remultiplexing operation may refer to an operation of adding audio, video, data or signaling information required after a stream is demultiplexed, and performing multiplexing again.

In the third scenario 430, the 3D broadcast retransmission apparatus 120 may demodulate the stream of the first broadcast network, and may remultiplex the demodulated stream, as shown in FIG. 4. The 3D broadcast retransmission apparatus 120 may modulate the remultiplexed stream by changing a modulation scheme and a channel between the first broadcast network and the retransmission network, and may generate a stream of the retransmission network.

A fourth scenario 440 among the retransmission scenarios may be generated by adding a transcoding operation to the third scenario 430.

In the fourth scenario 440, the 3D broadcast retransmission apparatus 120 may demodulate the stream of the first broadcast network, and may demultiplex the demodulated stream, as shown in FIG. 4. The 3D broadcast retransmission apparatus 120 may transcode the demultiplexed stream, and may multiplex the transcoded stream. The 3D broadcast retransmission apparatus 120 may modulate the multiplexed stream by changing a modulation scheme and a channel between the first broadcast network and the retransmission network, and may generate a stream of the retransmission network.

The fourth scenario 440 may refer to a remultiplexing scenario selected to increase a transmission efficiency of a channel by reducing a bit rate by changing a video and/or audio source coding scheme. Additionally, the fourth scenario 440 may refer to a remultiplexing scenario selected to change an image format, for example, a frame rate, a size of a broadcast image, and the like.

When a transport level, or a video level is changed, for example, when the third scenario 430 or the fourth scenario 440 is performed, the 3D broadcast retransmission apparatus 120 may extract 3D TV service information from a stream of a broadcast network, may update the extracted 3D TV service information, if necessary, and may reinsert the 3D TV service information into the stream of the retransmission network.

FIG. 5 is a block diagram illustrating the 3D broadcast reception apparatus 130 of FIG. 1.

Referring to FIG. 5, the 3D broadcast reception apparatus 130 may include a retransmission network receiver 510, a second broadcast network receiver 520, a service information extractor 530, a service information interpreting unit 540, a synchronization unit 550, and a 3D image synthesizing unit 560.

The retransmission network receiver 510 may receive a stream of a retransmission network from the 3D broadcast retransmission apparatus 120 through the retransmission network.

The second broadcast network receiver 520 may receive a stream of a second broadcast network from the broadcast server 110 through the second broadcast network.

The retransmission network receiver 510 and the second broadcast network receiver 520 may receive the stream of the retransmission network and the stream of the second broadcast network, respectively, at the same time. Additionally, the retransmission network receiver 510 and the second broadcast network receiver 520 may be included in the 3D broadcast reception apparatus 130, as shown in FIG. 5, or may be peripheral devices that are expansible via an interface, for example, a universal serial bus (USB), a Bluetooth, a serial cable, an external serial ATA (e-SATA), and the like.

The service information extractor 530 may extract 3D TV service information from the stream of the retransmission network received by the retransmission network receiver 510. The service information extractor 530 may also extract 3D TV service information from a signaling channel of the retransmission network, for example, a program map table (PMT), a switching I (SI), and a VCT.

The 3D TV service information extracted by the service information extractor 530 may be identical to 3D TV service information included in a stream of a first broadcast network, or may be 3D TV service information corrected by the 3D broadcast retransmission apparatus 120. For example, when a first scenario is performed, the 3D broadcast retransmission apparatus 120 may bypass the stream of the first broadcast network, and may transmit the stream of the first broadcast network through the retransmission network. In other words, since the stream of the retransmission network is identical to the stream of the first broadcast network, the 3D TV service information extracted by the service information extractor 530 may be identical to the 3D TV service information included in the stream of the first broadcast network.

Additionally, the 3D TV service information corrected by the 3D broadcast retransmission apparatus 120 may have the same format as the 3D TV service information included in the stream of the first broadcast network. For example, when a second scenario is performed, the 3D broadcast retransmission apparatus 120 may not remultiplex the stream of the first broadcast network. Accordingly, a format of the 3D TV service information included in the stream of the retransmission network may be identical to a format of the 3D TV service information included in the stream of the first broadcast network.

Furthermore, the 3D TV service information corrected by the 3D broadcast retransmission apparatus 120 may include additional service information, in addition to the 3D TV service information included in the stream of the first broadcast network.

The service information interpreting unit 540 may interpret the 3D TV service information extracted by the service information extractor 530.

For example, the service information interpreting unit 540 may interpret, based on the 3D TV service information extracted by the service information extractor 530, at least one of 3D TV service type information, identification information of the stream of the first broadcast network transmitted through the first broadcast network, identification information of the stream of the second broadcast network transmitted through the second broadcast network, location information of a left image included in the stream of the first broadcast network or the stream of the second broadcast network, location information of a right image included in the stream of the first broadcast network or the stream of the second broadcast network, video format information used to generate a 3D image by synthesizing an image included in the stream of the first broadcast network and an image included in the stream of the second broadcast network, and synchronization information of an image included in each of the stream of the first broadcast network and the stream of the second broadcast network. The first broadcast network and the second broadcast network may be different from each other.

In this example, the 3D TV service information may be identical to the 3D TV service information included in the stream of the first broadcast network, or may be 3D TV service information corrected by the 3D broadcast retransmission apparatus 120. The 3D TV service information corrected by the 3D broadcast retransmission apparatus 120 may have the same format as the 3D TV service information included in the stream of the first broadcast network, or may have a format including new change information.

In an example, when the 3D TV service information extracted by the service information extractor 530 is identical to, or has the same format as the 3D TV service information included in the stream of the first broadcast network, the service information interpreting unit 540 may interpret the extracted 3D TV service information in the same manner that a TV receiver reproduces a broadcast based on the stream of the first broadcast network.

In another example, when the format of the 3D TV service information extracted by the service information extractor 530 is different from the format of the 3D TV service information included in the stream of the first broadcast network, the 3D TV service information extracted by the service information extractor 530 may include additional service information, in addition to the 3D TV service information included in the stream of the first broadcast network.

In this example, the 3D TV service information extracted by the service information extractor 530 may include a variety of additional service information, for example, additional information used to identify a left image stream and a right image stream, or additional information for synchronization.

The additional service information may include, for example, stream identification information that is different from identification information of the stream of the first broadcast network. For example, an MPEG-2 TS may be used in the first broadcast network, and may be changed to a stream based on an IP, for example, a real-time transport protocol (RTP), an MPEG media transport (MMT), a dynamic adaptive streaming over hypertext transfer protocol (HTTP) (DASH), and the like, through remultiplexing in the retransmission network. In this example, service information of the first broadcast network may include a packet ID of the MPEG-2 TS, to identify image streams. Additionally, service information of the retransmission network may be changed to an IP address-port number, a service ID, a file name-offset, and the like, to identify image streams.

Additionally, the additional service information may be used to synchronize a left image and a right image. The service information interpreting unit 540 may interpret the additional service information based on a type of information used as left and right image synchronization information.

For example, when the broadcast server 110 uses a timestamp pair or a timestamp offset as left and right image synchronization information, the 3D broadcast retransmission apparatus 120 may perform re-stamping on the stream of the first broadcast network. In this example, the 3D broadcast retransmission apparatus 120 may not correct synchronization information in the 3D TV service information, and may transfer a timestamp change value N of an AU of the first broadcast network through separate signaling. Accordingly, the service information interpreting unit 540 may interpret the timestamp change value N in additional service information transmitted through separate signaling.

The synchronization unit 550 may acquire a left image and a right image of a 3D image that are to be output at the same time, based on the 3D TV service information interpreted by the service information interpreting unit 540, and may synchronize the acquired left image and the acquired right image. The left image and right image of the 3D image may be, for example, a retransmission network image included in the stream of the retransmission network, and a second broadcast network image included in the stream of the second broadcast network, respectively.

For example, the synchronization unit 550 may search for a left image and a right image matched to synchronization information interpreted in a left image stream and a right image stream identified by the service information interpreting unit 540. An elementary stream (ES) of each of the left image and the right image may be transferred to a decoder, based on stream or service identification information, for example, a packet ID of an MPEG-2 TS, an IP address-port number, a service ID, a file name-offset, and the like. A left frame and a right frame that are to be synchronized to an image may be identified based on synchronization information, for example, a presentation timestamp (PTS) offset and/or pair, a SMPTE timecode, a frame number, and the like, among decoded images.

The 3D image synthesizing unit 560 may synthesize the retransmission network image and the second broadcast network image that are to be identified by the synchronization unit 550, to generate a 3D image, and may output the 3D image.

For example, the 3D image synthesizing unit 560 may synthesize the retransmission network image and the second broadcast network image, using a binocular 3D image synthesis scheme.

In an example, when the 3D broadcast reception apparatus 130 also performs a function of outputting a screen of an image, the 3D image synthesizing unit 560 may synthesize the retransmission network image and the second broadcast network image to a 3D image and may output the 3D image, using a time-sharing scheme, or may output the 3D image using a film-type patterned retarder (FPR). In this example, the retransmission network image and the second broadcast network image may be a left image and a right image of the 3D image.

Additionally, the 3D image synthesizing unit 560 may synthesize the retransmission network image and the second broadcast network image to a 3D image, and may output the 3D image, using a glassless 3D display scheme, or other binocular 3D TV display schemes. The glassless 3D display scheme may include, for example, a parallax barrier glassless 3D display scheme, or a lenticular glassless 3D display scheme.

When the 3D broadcast reception apparatus 130 uses a separate device to output a 3D image, the 3D image synthesizing unit 560 may synthesize the retransmission network image and the second broadcast network image based on a binocular 3D image interface format.

For example, the 3D image synthesizing unit 560 may synthesize the retransmission network image and the second broadcast network image, using a Side by Side (SbS) format, a Top and Bottom (TaB) format, or a frame-sequential format. In the SbS format, and the TaB format, a screen may be halved and transferred. In the frame-sequential format, left and right frames of a screen may be alternately transferred.

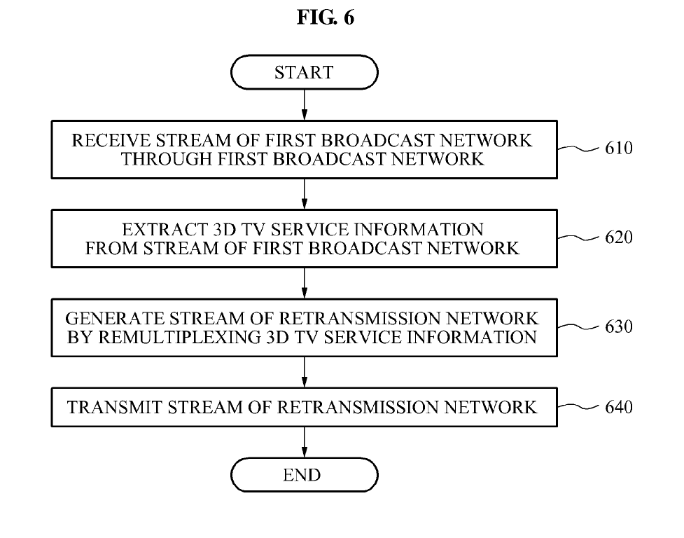

FIG. 6 is a flowchart illustrating a 3D broadcast retransmission method according to an embodiment of the present invention.

Referring to FIG. 6, in operation 610, the first broadcast network receiver 210 of FIG. 2 may receive a stream of a first broadcast network from the broadcast server 110 of FIG. 1 through the first broadcast network. Since the first broadcast network is a terrestrial 2D TV broadcast network, the stream of the first broadcast network may be a stream of a terrestrial broadcast network.

In operation 620, the remultiplexer 220 may extract 3D TV service information from the stream of the first broadcast network received in operation 610. The 3D TV service information extracted by the remultiplexer 220 may include at least one of 3D TV service type information, identification information of each of the stream of the first broadcast network and a stream of a second broadcast network, location information of a left image included in the stream of the first broadcast network or the stream of the second broadcast network, location information of a right image included in the stream of the first broadcast network or the stream of the second broadcast network, video format information used to generate a 3D image by synthesizing an image included in the stream of the first broadcast network and an image included in the stream of the second broadcast network, and synchronization information of an image included in each of the stream of the first broadcast network and the stream of the second broadcast network.

In operation 630, the remultiplexer 220 may remultiplex the 3D TV service information extracted in operation 620, based on a retransmission scenario, and may generate a stream of a retransmission network. The retransmission scenario used by the remultiplexer 220 may include at least one of a scenario for bypassing the stream of the first broadcast network, a scenario for remodulating or transmodulating the stream of the first broadcast network, a scenario for remodulating and remultiplexing the stream of the first broadcast network, and a scenario for remodulating, remultiplexing, and transcoding the stream of the first broadcast network.

When a portion of the 3D TV service information is changed, the remultiplexer 220 may update the extracted 3D TV service information based on a change in the 3D TV service information, and may transmit the updated 3D TV service information.

For example, during remultiplexing based on the retransmission scenario, identification information of a broadcast stream, for example, a broadcast channel number of a VCT in a PSIP, a program ID of a VCT, or a packet ID of an MPEG-2 TS, a service ID, an IP address-port number, and a file name-offset, may be changed. The remultiplexer 220 may change the identification information of the stream of the first broadcast network and the identification information of the stream of the second broadcast network, based on the broadcast channel number, the program ID, the packet ID, the service ID, the IP address-port number, or the file name-offset that is changed during the remultiplexing.

Additionally, during remultiplexing based on the retransmission scenario, transcoding, up-sampling, down-sampling, and changing of a frame rate may be performed on an image included in the stream of the first broadcast network. For example, the remultiplexer 220 may correct the video format information in the 3D TV service information extracted from the stream of the first broadcast network, based on video format information changed by the transcoding, the up-sampling, the down-sampling, and the changing of the frame rate during remultiplexing of the stream of the first broadcast network.

When the image included in the stream of the first broadcast network is remultiplexed or transcoded, the remultiplexer 220 may correct the synchronization information included in the 3D TV service information, or may transmit additional synchronization information.

In operation 640, the retransmission network transmitter 230 may transmit the stream of the retransmission network generated in operation 630 through the retransmission network.

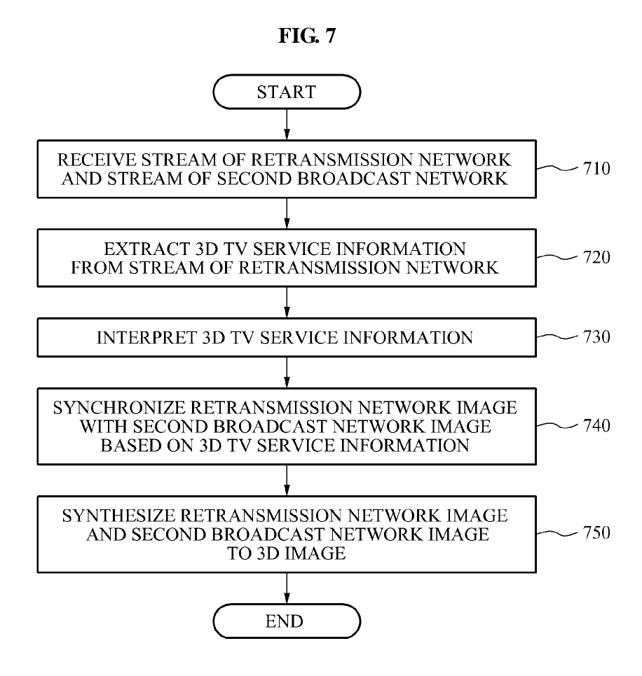

FIG. 7 is a flowchart illustrating a 3D broadcast reception method according to an embodiment of the present invention.

Referring to FIG. 7, in operation 710, the retransmission network receiver 510 and the second broadcast network receiver 520 of FIG. 5 may receive a stream of a retransmission network and a stream of a second broadcast network through the retransmission network and the second broadcast network from the 3D broadcast retransmission apparatus 120 and the broadcast server 110 of FIG. 1, respectively.

In operation 720, the service information extractor 530 may extract 3D TV service information from the stream of the retransmission network received in operation 710. For example, the service information extractor 530 may extract 3D TV service information from a signaling channel of the retransmission network, for example, a PMT, an SI, and a VCT.

The 3D TV service information extracted by the service information extractor 530 may be identical to 3D TV service information included in a stream of a first broadcast network, or may be 3D TV service information corrected by the 3D broadcast retransmission apparatus 120. The 3D TV service information corrected by the 3D broadcast retransmission apparatus 120 may have the same format as the 3D TV service information included in the stream of the first broadcast network. Additionally, the 3D TV service information corrected by the 3D broadcast retransmission apparatus 120 may include additional service information, in addition to the 3D TV service information included in the stream of the first broadcast network.

In operation 730, the service information interpreting unit 540 may interpret the 3D TV service information extracted in operation 720, and may acquire synchronization information or stream identification information required for 3D image synthesis based on the interpreted 3D TV service information.

In an example, when the 3D TV service information extracted by the service information extractor 530 has the same format as the 3D TV service information included in the stream of the first broadcast network, the service information interpreting unit 540 may interpret the extracted 3D TV service information in the same manner that a TV receiver reproduces a broadcast based on the stream of the first broadcast network.

In another example, a format of the 3D TV service information extracted by the service information extractor 530 may be different from a format of the 3D TV service information included in the stream of the first broadcast network. The 3D TV service information extracted by the service information extractor 530 may include additional service information, in addition to the 3D TV service information included in the stream of the first broadcast network.

In this example, the 3D TV service information extracted by the service information extractor 530 may include a variety of additional service information, for example, additional information used to identify a left image stream and a right image stream, or additional information for synchronization.

The additional service information may include, for example, stream identification information that is different from identification information of the stream of the first broadcast network. For example, an MPEG-2 TS may be used in the first broadcast network, and may be changed to a stream based on an IP, for example, an RTP, an MMT, a DASH, and the like, through remultiplexing in the retransmission network. In this example, service information of the first broadcast network may include a packet ID of the MPEG-2 TS, to identify image streams. Additionally, service information of the retransmission network may be changed to an IP address-port number, a service ID, a file name-offset, and the like, to identify image streams.

Additionally, the additional service information may be used to synchronize a left image and a right image. The service information interpreting unit 540 may interpret the additional service information based on a type of information used as left and right image synchronization information. For example, when the broadcast server 110 uses a timestamp pair or a timestamp offset as left and right image synchronization information, the 3D broadcast retransmission apparatus 120 may perform re-stamping on the stream of the first broadcast network. In this example, the 3D broadcast retransmission apparatus 120 may not correct synchronization information in the 3D TV service information, and may transfer a timestamp change value N of an AU of the first broadcast network through separate signaling. Accordingly, the service information interpreting unit 540 may interpret the timestamp change value N in additional service information transmitted through separate signaling.

In operation 740, the synchronization unit 550 may acquire a left image and a right image of a 3D image that are to be output at the same time, based on the 3D TV service information interpreted in operation 730, and may synchronize the acquired left image and the acquired right image. The left image and right image of the 3D image may be, for example, a retransmission network image included in the stream of the retransmission network, and a second broadcast network image included in the stream of the second broadcast network, respectively.

For example, the synchronization unit 550 may search for a left image and a right image matched to synchronization information interpreted in a left image stream and a right image stream identified by the service information interpreting unit 540. An ES of each of the left image and the right image may be transferred to a decoder, based on stream or service identification information, for example, a packet ID of an MPEG-2 TS, an IP address-port number, a service ID, a file name-offset, and the like. A left frame and a right frame that are to be synchronized to an image may be identified based on synchronization information, for example, a PTS offset and/or pair, a SMPTE timecode, a frame number, and the like, among decoded images.

In operation 750, the 3D image synthesizing unit 560 may synthesize the retransmission network image and the second broadcast network image that are synchronized in operation 740 to a 3D image, and may output the 3D image. For example, the 3D image synthesizing unit 560 may synthesize the retransmission network image and the second broadcast network image, using a binocular 3D image synthesis scheme.

In an example, when the 3D broadcast reception apparatus 130 also performs a function of outputting a screen of an image, the 3D image synthesizing unit 560 may synthesize the retransmission network image and the second broadcast network image to a 3D image and may output the 3D image, using a time-sharing scheme, or may output the 3D image using an FPR. In this example, the retransmission network image and the second broadcast network image may be a left image and a right image of the 3D image. In another example, when the 3D broadcast reception apparatus 130 uses a separate device to output a 3D image, the 3D image synthesizing unit 560 may synthesize the retransmission network image and the second broadcast network image based on a binocular 3D image interface format.

As described above, according to embodiments of the present invention, it is possible to maximize a coverage by retransmitting one of two images of a 3D image that is transmitted through a terrestrial broadcast network, using a heterogeneous broadcast network, for example, a cable broadcast network, a satellite broadcast network, and an IPTV broadcast network, in a convergence 3D TV in which the terrestrial broadcast network and the heterogeneous broadcast network are simultaneously used.

Additionally, according to embodiments of the present invention, when image-related information is changed during retransmitting of one of two images of a 3D image transmitted through a terrestrial broadcast network, using a heterogeneous broadcast network, additional service information may be provided. Thus, it is possible to enable synchronization between one of the two images retransmitted in a reception apparatus and the other image received from a broadcast server.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A three-dimensional (3D) broadcast retransmission apparatus, comprising:
a remultiplexer to remultiplex 3D TV service information in a received stream of a first broadcast network, based on a retransmission scenario, and to generate a stream of a retransmission network; and
a retransmission network transmitter to transmit the stream of the retransmission network through the retransmission network.

2. The 3D broadcast retransmission apparatus of claim 1, wherein the retransmission scenario comprises at least one of a scenario for bypassing the stream of the first broadcast network, a scenario for remodulating or transmodulating the stream of the first broadcast network, a scenario for remodulating and remultiplexing the stream of the first broadcast network, and a scenario for remodulating, remultiplexing, and transcoding the stream of the first broadcast network.

3. The 3D broadcast retransmission apparatus of claim 2, wherein when either the scenario for bypassing the stream of the first broadcast network, or the scenario for remodulating or transmodulating the stream of the first broadcast network is used as the retransmission scenario, the remultiplexer generates a stream of the retransmission network that comprises the same type of 3D TV service information as the 3D TV service information in the stream of the first broadcast network.

4. The 3D broadcast retransmission apparatus of claim 2, wherein when either the scenario for remodulating and remultiplexing the stream of the first broadcast network, or the scenario for remodulating, remultiplexing, and transcoding the stream of the first broadcast network is used as the retransmission scenario, the remultiplexer extracts the 3D TV service information from the stream of the first broadcast network, and reinserts the extracted 3D TV service information.

5. The 3D broadcast retransmission apparatus of claim 1, wherein the 3D TV service information comprises at least one of 3D TV service type information, identification information of the stream of the first broadcast network transmitted through the first broadcast network, identification information of a stream of a second broadcast network transmitted through the second broadcast network, the second broadcast network being different from the first broadcast network, location information of a left image included in the stream of the first broadcast network or the stream of the second broadcast network, location information of a right image included in the stream of the first broadcast network or the stream of the second broadcast network, video format information used to generate a 3D image by synthesizing an image in the stream of the first broadcast network and an image in the stream of the second broadcast network, and synchronization information of an image in each of the stream of the first broadcast network and the stream of the second broadcast network.

6. The 3D broadcast retransmission apparatus of claim 5, wherein when a broadcast channel number, a packet identifier (ID) of a moving picture experts group-2 transport stream (MPEG-2 TS), an Internet protocol (IP) address-port number, a service ID, or a file name-offset is changed, the remultiplexer changes the identification information of the stream of the first broadcast network and the identification information of the stream of the second broadcast network, based on the changed broadcast channel number, the changed packet ID, the changed IP address-port number, the changed service ID, or the changed file name-offset.

7. The 3D broadcast retransmission apparatus of claim 5, wherein when at least one of transcoding, up-sampling, down-sampling, and changing of a frame rate is performed on the image in the stream of the first broadcast network, the remultiplexer corrects the identification information of the stream of the first broadcast network, the identification information of the stream of the second broadcast network, the video format information, and the synchronization information, based on information changed during remultiplexing of the stream of the first broadcast network.

8. The 3D broadcast retransmission apparatus of claim 5, wherein when at least one of transcoding, up-sampling, down-sampling, and changing of a frame rate is performed on the image in the stream of the first broadcast network, the remultiplexer transmits, using a separate signaling scheme, the identification information of the stream of the first broadcast network, the identification information of the stream of the second broadcast network, the video format information, and the synchronization information that are changed during remultiplexing of the stream of the first broadcast network.

9. The 3D broadcast retransmission apparatus of claim 5, wherein when at least one of remultiplexing and transcoding is performed on the image in the stream of the first broadcast network, the remultiplexer corrects the synchronization information.

10. A three-dimensional (3D) broadcast reception apparatus, comprising:
a service information extractor to extract 3D TV service information from a stream of a retransmission network received from a 3D broadcast retransmission apparatus, the stream of the retransmission network being a stream of a first broadcast network received from a broadcast server via the first broadcast network and retransmitted by the 3D broadcast retransmission apparatus;
a synchronization unit to synchronize a retransmission network image included in the stream of the retransmission network with a second broadcast network image included in a stream of a second broadcast network received from the broadcast server, based on the 3D TV service information; and
a 3D image synthesizing unit to synthesize the retransmission network image and the second broadcast network image to a 3D image, and to output the 3D image.

11. The 3D broadcast reception apparatus of claim 10, wherein the service information extractor extracts 3D TV service information from a signaling channel of the retransmission network.

12. The 3D broadcast reception apparatus of claim 10, further comprising:
a service information interpreting unit to interpret the 3D TV service information extracted by the service information extractor, and to acquire information required for 3D image synthesis based on a result of the interpreted 3D TV service information.

13. The 3D broadcast reception apparatus of claim 12, wherein when the extracted 3D TV service information comprises additional service information in addition to 3D TV service information included in the stream of the first broadcast network, the service information interpreting unit interprets the additional service information based on a type of information used as left and right image synchronization information.

14. A three-dimensional (3D) broadcast service providing system, comprising:
a broadcast server to transmit a stream of a first broadcast network through the first broadcast network, and to transmit a stream of a second broadcast network through the second broadcast network, the stream of the first broadcast network being a terrestrial stream and corresponding to the stream of the second broadcast network;
a 3D broadcast retransmission apparatus to remultiplex the stream of the first broadcast network received through the first broadcast network, to generate a stream of a retransmission network, and to transmit the stream of the retransmission network through the retransmission network; and
a 3D broadcast reception apparatus to receive the stream of the retransmission network and the stream of the second broadcast network, to synchronize a retransmission network image included in the stream of the retransmission network with a second broadcast network image included in the stream of the second broadcast network, and to synthesize the retransmission network image and the second broadcast network image to a 3D image.

15. A three-dimensional (3D) broadcast retransmission method, comprising:
remultiplexing 3D TV service information in a received stream of a first broadcast network based on a retransmission scenario, and generating a stream of a retransmission network; and
transmitting the stream of the retransmission network through the retransmission network.

16. The 3D broadcast retransmission method of claim 15, wherein the retransmission scenario comprises at least one of a scenario for bypassing the stream of the first broadcast network, a scenario for remodulating or transmodulating the stream of the first broadcast network, a scenario for remodulating and remultiplexing the stream of the first broadcast network, and a scenario for remodulating, remultiplexing, and transcoding the stream of the first broadcast network.

17. The 3D broadcast retransmission method of claim 15, wherein the 3D TV service information comprises at least one of 3D TV service type information, identification information of the stream of the first broadcast network transmitted through the first broadcast network, identification information of a stream of a second broadcast network transmitted through the second broadcast network, the second broadcast network being different from the first broadcast network, location information of a left image included in the stream of the first broadcast network or the stream of the second broadcast network, location information of a right image included in the stream of the first broadcast network or the stream of the second broadcast network, video format information used to generate a 3D image by synthesizing an image in the stream of the first broadcast network and an image in the stream of the second broadcast network, and synchronization information of an image in each of the stream of the first broadcast network and the stream of the second broadcast network.

18. The 3D broadcast retransmission method of claim 17, wherein the remultiplexing comprises, when at least one of transcoding, up-sampling, down-sampling, and changing of a frame rate is performed on the image in the stream of the first broadcast network, correcting the identification information of the stream of the first broadcast network, the identification information of the stream of the second broadcast network, the video format information, and the synchronization information, based on information changed during remultiplexing of the stream of the first broadcast network.

19. The 3D broadcast retransmission method of claim 17, wherein the remultiplexing comprises, when at least one of transcoding, up-sampling, down-sampling, and changing of a frame rate is performed on the image in the stream of the first broadcast network, transmitting, using a separate signaling scheme, the identification information of the stream of the first broadcast network, the identification information of the stream of the second broadcast network, the video format information, and the synchronization information that are changed during remultiplexing of the stream of the first broadcast network.

20. A three-dimensional (3D) broadcast reception method, comprising:
extracting 3D TV service information from a stream of a retransmission network received from a 3D broadcast retransmission apparatus, the stream of the retransmission network being a stream of a first broadcast network received from a broadcast server via the first broadcast network and retransmitted by the 3D broadcast retransmission apparatus;
synchronizing a retransmission network image included in the stream of the retransmission network with a second broadcast network image included in a stream of a second broadcast network received from the broadcast server, based on the 3D TV service information; and
synthesizing the retransmission network image and the second broadcast network image to a 3D image, and outputting the 3D image.
